(19) United States
(12) Patent Application Publication
(10) Pub. No.: US 2006/0232964 A1
(43) Pub. Date: Oct. 19, 2006

(54) Lighting device, backlight device, and liquid crystal display device

(76) Inventors: Kazunori Hoshi, Nigata-shi (JP); Naoto Ohtani, Nigata-shi (JP); Ichiroh Aoyagi, Nigata-shi (JP); Atsushi Sekikawa, Minamikanbara-gun (JP)

Correspondence Address: MORRISON & FOERSTER LLP, 755 PAGE MILL RD, PALO ALTO, CA, 94304-1018, US

(21) Appl. No.: 11/373,716

(22) Filed: Mar. 10, 2006

(30) Foreign Application Priority Data
Mar. 10, 2005 (JP) 2005-67973

(51) Int. Cl. G02F 1/13357

(52) U.S. Cl. 362/231; 362/561; 362/613

(57) ABSTRACT

The present invention is made to realize (i) a lighting device capable of emitting uniform surface light having high luminance and a wide color reproduction range, and (ii) a liquid crystal display device including the lighting device. Such a lighting device of the present invention includes: (i) a GB lamp for emitting blue and green light; (ii) an RLED for emitting red light; and (iii) a light emitting section for irradiating, to outside, the light emitted from each of the GB lamp and the RLED. The light emitting section has an upper surface serving as a light emitting surface, and the GB lamp and the RLED are provided under the light emitting section. Further, the RLED is so provided as to emit the light in a direction that is not perpendicular to the light emitting surface.

This Nonprovisional application claims priority under U.S.C. §119(a) on Patent Application No. 2005/67973 filed in Japan on Mar. 10, 2005, the entire contents of which are hereby incorporated by reference.

### FIELD OF THE INVENTION

The present invention relates to a lighting device, and a liquid crystal display device including the lighting device. More specifically, the present invention relates to (i) a lighting device using (a) a discharge tube such as a cold-cathode tube, and (b) an LED (light emitting diode); and (ii) a liquid crystal display device including the lighting device.

### BACKGROUND OF THE INVENTION

Conventionally, each of a discharge tube such as a cold-cathode tube, and an LED (light emitting diode) has been used mainly as a light source of a backlight of a liquid crystal display device. The cold-cathode tube emits visible light as follows: mercury in the cold-cathode tube is so excited as to emit an ultraviolet ray, and the ultraviolet ray thus emitted is incidented on a phosphor (fluorescent material) applied to an inner wall of a glass tube of the cold-cathode tube. Generally, such a phosphor is obtained by combining an R (red) phosphor, a G (green) phosphor, and a B (blue) phosphor, so that the visible light to be emitted from the cold-cathode tube becomes white.

On the other hand, the LED emits light as follows: an electron, and a positive hole (electron hole) generated by applying an orthodromic voltage to an LED chip are recombined such that the electron and the positive hole become stable with energy smaller than each energy of the positive hole and the electron, with the result that extra energy is converted into light. The LED chip is formed by joining a p-type semiconductor (+) with an n-type semiconductor (−).

In the meanwhile, the backlight used for the liquid crystal display device adopts either (i) a method (vertical type) for allowing uniform surface light emitting with the use of a light source provided just below a liquid crystal panel; or (ii) a method (edge light type) for changing (a) light emitted from a light source provided in an end portion of the liquid crystal panel, into (b) surface light with the use of a light guiding member.

Here, FIG. 9 illustrates a typical structure of a liquid crystal display device using such an edge light type backlight using the cold-cathode tube. As shown in FIG. 9, the liquid crystal display device includes: (i) a light guiding member 100 for guiding light, which has come via an end surface of the light guiding member 100 of the liquid crystal display device, so that the light is uniformly incidented on a surface of the liquid crystal panel; (ii) a cold-cathode tube 110 for irradiating the light to the light guide member 100; (iii) a reflector 120 for reflecting the light, which is emitted from the cold-cathode tube 110, so that the light is irradiated to the light guiding member 100; (iv) a reflecting sheet 130 for reflecting the light, which passes through the light guiding member 100, so that the light is irradiated to the surface of light guiding member 100; (v) a diffusing sheet 140 for diffusing the light, outwardly with respect to the surface of the light guiding member 100; and (vi) a lens sheet 150 for further collecting the light.

However, the liquid crystal display device using such an edge light type backlight uses the light guiding member so as to change (i) the light having come from the end surface of the liquid crystal panel, into (ii) the surface light. Therefore, in cases where the liquid crystal panel (screen) is large, it is difficult to realize uniform surface light over the entire screen. Also in this case, it is difficult to secure sufficient luminance from the light having come from the end surface of the liquid crystal panel. Moreover, such a large liquid crystal panel requires a large light guiding member, so that the weight of the liquid crystal display device becomes heavier. This is not practical.

Further, in the case where the cold-cathode tube is used as the backlight, the white color, which is essential for color reproducibility, is obtained by adjusting and changing a combination ratio of the R phosphor, the G phosphor, and the B phosphor. However, the combining of the R phosphor causes decrease of the luminance, according to a relation between the luminance and a luminescence spectrum of the light having passed through the R phosphor. Particularly, it is known that the combining of the R phosphor causes decrease of the luminance, as the luminescence-spectrum of the light having passed through the R phosphor is similar to that of light having the pure red color (the luminance in the case of using the RGB phosphor cold-cathode tube is decreased by 10% through 15%, as compared with that in the case of using a GB phosphor cold-cathode tube). Accordingly, in cases where an attempt is made for attainment of high luminance in the case of using such a cold-cathode tube, the peak in the luminescence spectrum of the light having passed through the R phosphor tends to be slightly shifted to an orange color side, i.e., tends to come in a slightly shorter wavelength. This narrows a color reproduction range.

Here, FIG. 10 illustrates a general luminescence spectrum of the light emitted from such a cold-cathode tube. FIG. 11 illustrates a general luminescence spectrum of the light having just passed through the liquid crystal panel of the liquid crystal display device using the cold-cathode tube as the backlight. FIG. 12 is a diagram illustrating a comparison between (i) a color reproduction range (see the inside of a triangle indicated by a dashed line) of the liquid crystal panel of the liquid crystal display device using the cold-cathode tube as the backlight, and (ii) a chromaticity region defined by the NTSC.

See FIG. 10 and FIG. 11. For attainment of high luminance, such a conventional cold-cathode tube uses, as the R phosphor, a phosphor that causes light to have a peak coming in a wavelength falling within a range from approximately 610 nm to approximately 620 nm in the luminescence spectrum. Light having a color similar to the pure red has a peak coming in a wavelength falling within a range from approximately 630 nm to approximately 640 nm. A comparison of the peaks clarifies that the peak of the light having passed through the R phosphor is shifted to the orange color side with respect to the peak of the light having the color similar to the pure red. In other words, the peak of the light having passed through the R phosphor comes in a wavelength shorter than the wavelength in which the peak of the light having the color similar to the pure red comes. Accordingly, the liquid crystal display device using the cold-cathode tube for the backlight has a color reproduction range whose area is approximately 74.2% of the chromaticity region defined by the NTSC, as shown in FIG. 12. Such a color reproduction range is narrow.

Proposed in light of this are a vertical type liquid crystal display device, and an edge light type liquid crystal display device, each of which uses RGB (white) LEDs as light sources. Each of such liquid crystal display devices allows high color reproducibility, but requires many LEDs. Therefore, the liquid crystal display device suffers from such problems as high power consumption, high heat emission, and high cost.

Proposed in light of this is a liquid crystal display device using a backlight including both a phosphor tube and an LED. See, e.g., Japanese Unexamined Patent Publication Tokukai 2004-139876/2004 (published on May 13, 2004; hereinafter, referred to as “Patent document 1”). Described in Patent document 1 is a liquid crystal display device including a vertical type backlight having a phosphor tube and an LED.

However, a plurality of LEDs are provided in the longitudinal direction of the phosphor tube such that a light emitting portion of each of the LEDs is oriented in the direction of a liquid crystal panel of the structure described in Patent document 1. Accordingly, the light emitting direction of the LED corresponds to the direction of the liquid crystal panel. Moreover, the phosphor tube used together with the LED is a light source having a line-like shape, whereas the LED is a light source having a spot-like shape. These make it difficult to obtain light uniformly passing through an entire surface of the liquid crystal panel. In other words, the light emitted from the LED is not uniformly mixed with the light emitted from the phosphor tube, with the result that it is difficult to emit light which passes uniformly through the entire surface of the liquid crystal panel.

### SUMMARY OF THE INVENTION

The present invention is made in view of the problems, and its object is to realize (i) a lighting device which allows high luminance and wide range color reproducibility, and which can emit uniform light from an entire surface; and (ii) a liquid crystal display device including the lighting device.

To achieve the object, a lighting device according to the present invention includes: a first light source for emitting light having one or more colors; one or more second light sources each for emitting light having a color different from the colors of the light emitted from the first light source; and an irradiating section for irradiating, to outside, the light emitted from the first light source and each of the second light sources, the irradiating section having an upper surface which serves as an irradiation surface, the first light source and the second light source being provided under the irradiating section, the second light source being provided such that a light emitting direction in which the second light source emits the light does not correspond to a direction perpendicular to the irradiation surface.

According to the structure above, the lighting device includes the first light source and the second light sources. The first light source is the light source for emitting the light having one or more colors, whereas each of the second light sources is the light source for emitting the light having the color different from the colors of the light emitted from the first light source. The light emitted from each of the first light source and the second light source is irradiated to outside via the irradiating section.

Further, the upper surface of the irradiating section serves as the irradiation surface, and the first light source and the second light source are provided under the irradiating section. In other words, the first light source and the second light source are provided on a side opposite to a portion, via which the light is irradiated to outside, of the irradiating section. That is, the first light source and the second light source are provided just below the irradiating section.

The first light source and the second light source are provided as such, so that a light source suitable for a color to be used can be used. This allows a wide color reproduction range of the light to be irradiated to outside. Further, it is possible to use a light source suitable for a color and luminance of the light to be irradiated to outside. This allows improvement in freedom in selecting a light source.

Further, the lighting device is arranged such that the light emitting direction of the second light source does not correspond to a direction perpendicular to the irradiation surface. Here, the wording “light emitting direction of the second light source” refers to a direction in which the second light source emits the light, but mainly refers to a direction in which a light beam, having the largest light amount (light intensity) in the light emitted from the second light source, travels. In other words, the wording “light emitting direction of the second light source” refers to a direction in which a light beam, corresponding to the peak of the intensity distribution of the light to be emitted from the second light source, travels.

Note that, for example, in cases where the light is irradiated from the irradiating section to the outside in a direction perpendicular to the irradiation surface, the second light source is provided such that the light emitting direction of the second light source does not corresponds to the direction of the light to be emitted from the irradiating section.

By providing the second light source in this way, the light emitting direction of the second light source can be changed. Specifically, consider a case where the light emitted from the first light source, and the light emitted from the second light source are mixed with each other, and where the light thus mixed is irradiated to outside. In this case, the light emitting direction of the second light source is set in accordance with (i) the light emitting direction of the first light source, (ii) the light amount thereof, and the like, with the result that uniform surface light can be emitted via the entire irradiation surface. Further, because the different types of light source are used, the luminance can be also improved.

A backlight device according to the present invention includes: (a) a line-like light source; and (b) one or more light source surfaces, each of which includes a plurality of spot-like light sources, the backlight device mixing (i) light emitted from the line-like light source, with (ii) light emitted from each of the spot-like light sources, each of the light source surfaces leaning, to a flat surface including the line-like light source, in a direction of a light irradiation surface that is a surface opposite to the flat surface including the line-like light source.

As such, the light source surface including the spot-like light sources leans to the flat surface including the line-like light source, in the direction of the light irradiation surface. Accordingly, the light emitted from the light sources (spot-like light source and the line-like light source) can be efficiently mixed with each other. This makes it possible to irradiate, to the light irradiation surface, light having high color reproducibility and high luminance.

Additional objects, features, and strengths of the present invention will be made clear by the description below. Further, the advantages of the present invention will be evident from the following explanation in reference to the drawings.

### BRIEF DESCRIPTION OF THE DRAWINGS

FIG. 1 illustrates one embodiment of the present invention, and is a perspective view schematically illustrating a backlight unit.

FIG. 2 illustrates one embodiment of the present invention, and is a cross sectional view schematically illustrating a liquid crystal display device.

FIG. 3 illustrates one embodiment of the present invention, and is a cross sectional view schematically illustrating the backlight unit.

FIG. 4 illustrates one embodiment of the present invention, and is a plan view schematically illustrating the backlight unit.

FIG. 5 illustrates one embodiment of the present invention, and is a diagram illustrating light emitted from each of a GB lamp and an RLED.

FIG. 6 illustrates one embodiment of the present invention, and is a diagram illustrating a luminescence spectrum of light emitted from the backlight unit.

FIG. 7 illustrates one embodiment of the present invention, and is a diagram illustrating a luminescence spectrum of light emitted from the liquid crystal display device including the backlight unit.

FIG. 8 illustrates one embodiment of the present invention, and is a diagram illustrating an NTSC ratio expressing color reproducibility of the liquid crystal display device.

FIG. 9 is a cross sectional view illustrating a typical structure of a liquid crystal display device using a conventional backlight.

FIG. 10 is a diagram illustrating a general luminescence spectrum of light emitted from a conventional cold-cathode tube.

FIG. 11 is a diagram illustrating a general luminescence spectrum of light which was emitted from the conventional cold-cathode tube used as the backlight in the liquid crystal display device, and which has just passed through a liquid crystal panel of the liquid crystal display device.

FIG. 12 is a diagram illustrating an NTSC ratio expressing color reproduction range of the liquid crystal display device using the conventional cold-cathode tube as the backlight.

### DESCRIPTION OF THE EMBODIMENTS

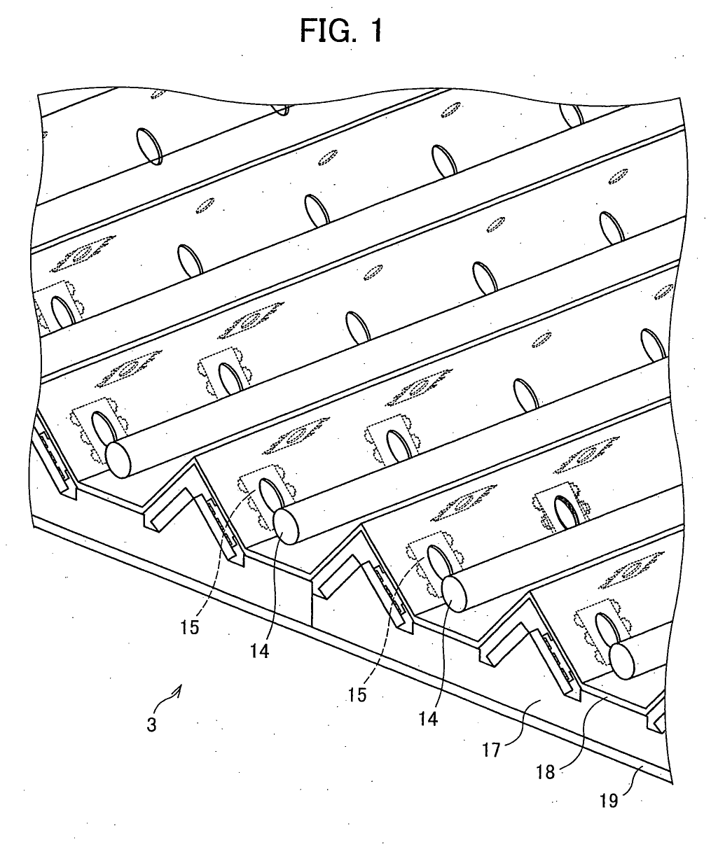

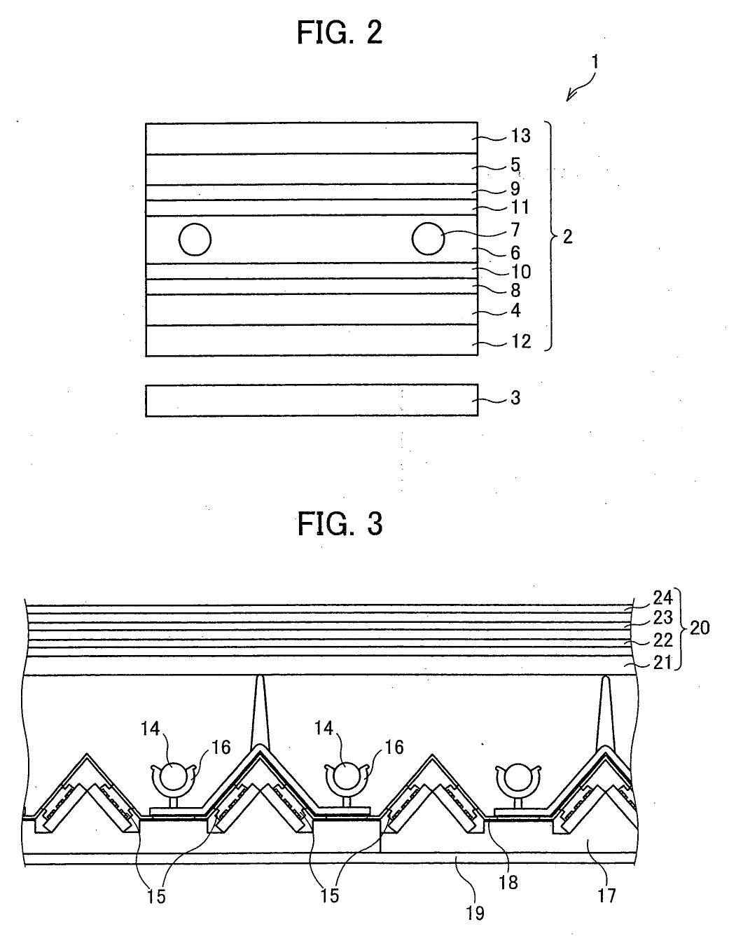

One embodiment of the present invention will be described below with reference to FIG. 1 through FIG. 8. FIG. 2 is a cross sectional view schematically illustrating a liquid crystal display device 1 according to the present embodiment. As shown in FIG. 2, the liquid crystal display device 1 includes a liquid crystal cell. 2, and a backlight unit (lighting device) 3.

The liquid crystal cell 2 is a liquid crystal panel in which a liquid crystal layer 6 filled with liquid crystal molecules is sandwiched between glass substrates 4 and 5. Spacers 7 each having, e.g., either a spherical shape or a pillar shape are provided between the glass substrates 4 and 5 such that a certain space is kept between the glass substrates 4 and 5. Provided on one of the glass substrates 4 and 5 is a pixel electrode 8. Provided on the other one of the glass substrates 4 and 5 is a counter electrode 9. Further, the pixel electrode 8 and the counter electrode 9 have inner surfaces on which alignment films 10 and 11 are provided, respectively. The alignment films 10 and 11 causes the liquid crystal molecules to align in a certain direction. Further, the glass substrates 4 and 5 have outer surfaces on which polarizing plates 12 and 13 are provided, respectively. Note that the liquid crystal cell provided in the liquid crystal display device 1 of the present invention is not limited to the liquid crystal cell having such a structure, and a liquid crystal cell having a generally usable structure is applicable to the liquid crystal cell provided in the liquid crystal display device 1 of the present invention.

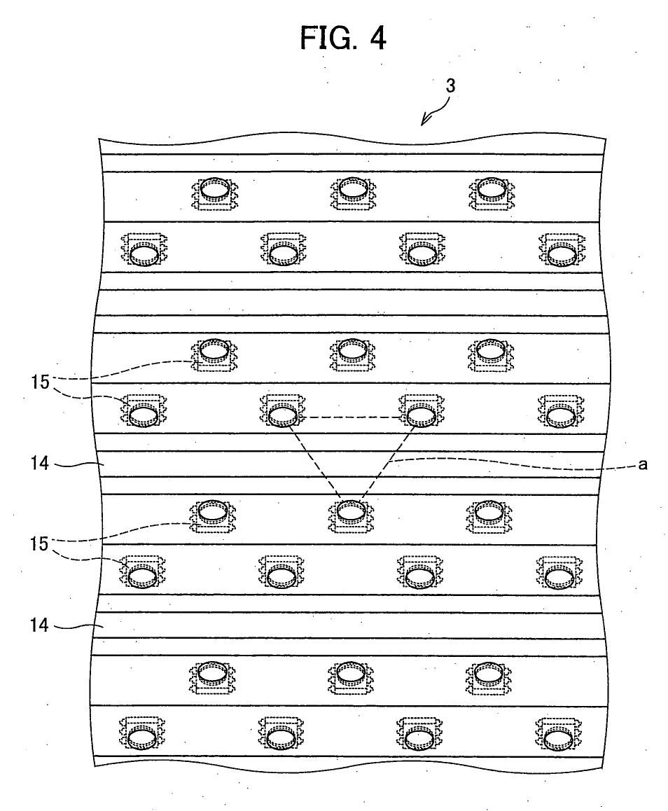

The backlight unit 3 is an external light emitter for realizing display in the liquid crystal display device 1. FIG. 1 is a perspective view schematically illustrating a structure of the backlight unit 3 of the present embodiment. FIG. 3 is a cross sectional view schematically illustrating the structure of the backlight unit 3. FIG. 4 is a plan view schematically illustrating the structure of the backlight unit 3.

As shown in FIG. 1, FIG. 3, and FIG. 4, the backlight unit 3 includes GB lamps (first light sources) 14, RLEDs (second light sources) 15, lamp clips 16, a base 17, reflecting plates 18, a back angle 19, and a light emitting section (irradiating section) 20.

Each of the GB lamps 14 is a cold-cathode tube used as a light source. Specifically, the GB lamp 14 is a phosphor tube having an inside to which a G (green) phosphor and a B (blue) phosphor are applied. Therefore, the cold-cathode tube emits green and blue visible light when the phosphors receive ultraviolet rays generated, by way of discharge, from mercury filled in the cold-cathode tube. The GB lamp 14 has an elongate cylindrical shape. In the present embodiment, the GB lamp 14 is so provided in the backlight unit 3 that the longitudinal direction of the GB lamp 14 corresponds to the direction in which the longitudinal sides of the liquid crystal cell 2 extend. Moreover, the GB lamp 14 is held by each of the lamp clips 16.

Each of the RLEDs 15 is a light emitting diode for emitting light whose color is R (red). The RLED 15 is fixed by the base 17. The base 17 has such a structure that a combination of a projection portion and a flat portion repeatedly appears. The projection portion and the flat portion of the base 17 extend in the longitudinal direction of the GB lamp 14. The RLED 15 is provided in a slope portion of the projection portion of the base 17. Details about arrangements, etc., of the GB lamps 14 and RLEDs 15 will be explained later.

The light emission by each of the GB lamp 14 and the RLED 15 causes heat emission. In other words, the use of the backlight unit 3 causes temperature increase inside the backlight unit 3. For this reason, it is preferable that the base 17 serve to radiate the heat. In view of this, it is preferable that the base 17 be made of, e.g., aluminum.

As such, the backlight unit 3 of the present embodiment has such a structure that uses the cold-cathode tube as the light source for emitting the green light and the blue light, and that uses the LED as the light source for emitting the red light. In other words, the backlight 3 uses, as a light source, the combination of the cold-cathode tube and the LED.

The light emitted from such a light source as the GB lamp 14 or the RLED 15 is efficiently reflected to the light emitting section 20 by each of the reflecting plates 18. The reflecting plate 18 is in the form of either a sheet or a plate, and the shape of the reflecting plate 18 matches with the projecting portion and the flat portion of the base 17. Specifically, the reflecting plate 18 is formed on and along the base 17 so as to almost fully-cover the base 17, but so as not to cover a light emitting portion, which is exposed in the base 17, of the RLED 15.

Further, reflection by the projection portion of the reflecting plate 18 allows improvement of unevenness in luminance of the light emitted from the GB lamp 14. Note that the reflecting plate 18 may be any sheet or plate that can reflect light; however, it is preferable that the reflecting plate 18 have a reflectance as high as possible. Examples of such a reflecting plate 18 include: (i) a sheet made of a white PET (polyethylene terephthalate), (ii) a metal plate on which the sheet made of the white PET is provided, (iii) a sheet subjected to a silver deposition process, and the like.

The lamp clip 16 holds the GB lamps 14 such that the GB lamps 14 are respectively positioned in predetermined positions. The lamp clip 16 is provided on the reflecting plate 18. Specifically, the lamp clip 16 is provided so as to cover a projection portion, and so as to partially cover flat portions respectively positioned on both sides of the projection portion. Further, the lamp clip 16 has a supporting member projecting from the top of the projection portion to the light emitting section 20. The lamp clip 16 thus provided makes it possible to support and fix the GB lamps 14 such that the GB lamps 14 is positioned in the predetermined positions over the both sides of the projection portion.

The supporting member projecting from the top of the projection portion supports the light emitting section 20. In other words, the supporting member supports the light emitting section 20, so that distance is unvaried between each of the GB lamps. 14 and the light emitting section 20 in the backlight unit 3, and distance is unvaried between each of the RLEDs 15 and the light emitting section 20 in the backlight unit 3. Note that one or more lamp clips 16 may be provided along the longitudinal sides of the GB lamp 14. In other words, the number of the lamp clips 16 is not limited as long as the lamp clips 16 hold the GB lamp 14 and make it possible that: the distance is unvaried between each of the GB lamps 14 and the light emitting section 20, and the distance is unvaried between each of the RLEDs 15 and the light emitting section 20.

The light emitting section 20 receives the light emitted from each of the GB lamp 14 and the RLED 15, and irradiates the received light to the liquid crystal cell 2. The light emitting section 20 has an upper surface which serves as a light emitting surface (irradiation surface) and which is made up of a plurality of layers. Specifically, the light emitting section 20 is arranged such that a diffusing plate 21, a diffusing sheet 22, a lens sheet 23, and a luminance increase sheet 24 are provided on top of each other in this order from the one facing the GB lamp 14 and the RLED 15.

The diffusing plate 21 scatters and diffuses the light emitted from each of the GB lamp 14 and the RLED 15. This makes it possible to uniformize the unevenness in the luminance of the light emitted from the light sources (the GB lamp 14 and the RLED 15). The diffusing plate 21 may be made of any material as long as the unevenness in the luminance of the light is uniformed; however, the diffusing plate 21 can be made of, e.g., a plastic containing a diffusing agent; and the like. Further, the diffusing plate 21 is the bottom layer, i.e., is provided under the below-mentioned sheets (diffusing sheet 22, the lens sheet 23, and the luminance increase sheet 24) so as to prevent sag of the sheets.

The diffusing sheet 22 further diffuses the light having emitted from the light sources (the GB lamp 14 and the RLED 15) via the diffusing plate 21. This makes it possible to further uniformize the light to be irradiated from the light emitting section 20 to the liquid crystal cell 2. The diffusing sheet 22 is made of a material containing a diffusing agent, and has a satin finished surface in which beads and the like are provided. Such a satin finished surface of the diffusing sheet 22 allows diffusion of the light passing therethrough.

The lens sheet 23 is a sheet for collecting the light emitted from the light sources (the GB lamp 14 and the RLED 15) via the diffusing plate 21 and the diffusing sheet 22, with the result that front luminance is improved. The lens sheet 23 has a surface which faces the luminance increase sheet 24 and on which a plurality of lenses each having a prism shape are provided. Such prism shaped lenses of the lens sheet 23 collects the light passing therethrough, with the result that the front luminance is improved.

The luminance increase sheet 24 is a sheet for further improving the luminance of the light to be irradiated to the liquid crystal cell 2. The improvement of the luminance is attained by using reflected light which does not pass through the polarizing plate 12 of the liquid crystal cell 2. In other words, the luminance increase sheet 24 has a function of reflecting the light, and a function of polarizing the light. Therefore, the luminance increase sheet 24 polarizes and reflects, to the liquid crystal cell 2, the light reflected by the polarizing plate 12. This allows increase of an amount of the light passing through the polarizing plate 12, with the result that the luminance can be increased.

The back angle 19 is a member serving as a skeletal structure of components, which include the aforementioned members, of the backlight unit 3. Provided on such a back angle 19 is the base 17. It is preferable that the back angle 19 be made of a material that is solid to some extent. Specifically, it is preferable that the back angle 19 be made of a metal such as aluminum.

Here, the following specifically explains the respective positions in which the GB lamp 14 and the RLED 15 are provided. See FIG. 1, FIG. 3, and FIG. 4. The GB lamps 14 each having the elongate shape are provided in the backlight unit 3 according to the present embodiment. Specifically, each of the GB lamps 14 are supported by each of the lamp clips 16 so as to be positioned over the flat portion of the base 17.

Further, the GB lamps 14 are so provided that the longitudinal sides thereof are positioned in the same direction, i.e., are so provided as to be parallel to one another. Moreover, the GB lamps 14 are so provided that distance is even between adjacent GB lamps 14. By providing the GB lamps 14 in this way, the light to be emitted from each of the GB lamps 14 can be more uniform surface light. Note that the positions in which the GB lamps 14 are provided are not limited to this. Further, the distance between the GB lamps 14 may be arbitrarily set in consideration of (i) the thickness (diameter) of each of the GB lamps 14 to be used, (ii) the intensity of the light that can be emitted from each of the GB lamps 14, and the like.

The RLEDs 15 are respectively provided, under the reflecting plate 18, in the slopes of the projection portions of the base 17. Specifically, the RLEDs 15 are so provided that the light emitting surfaces of the RLEDs 15 are parallel to the slopes of the projection portions of the base 17, respectively. Further, a plurality of RLEDs 15 are provided in a slope of a projection portion, which extends in the longitudinal direction of the GB lamp 14, of the base 17. Intervals are even between the RLEDs 15 provided in the slope.

The GB lamp 14 is sandwiched by such RLEDs 15 provided in each slope in this way. Further, the RLEDs 15 provided in one slope, and the RLEDs 15 provided in the other slope sandwiches the GB lamp 14 such that the direction of the light emitted from each of the RLEDs 15 thus sandwiching the GB lamps 14 crosses with the direction perpendicular to the irradiation surface, to which the GB lamp 14 emits the light, of the light emitting section 20.

Further, the RLEDs 15 are provided along the longitudinal sides of one GB lamp 14 so as to sandwich the GB lamp 14 in a cross-stitch (alternate) manner. That is, the RLEDs 15 are provided such that: a RLED 15 is so provided in one slope as to face, with the GB lamp 14 therebetween, RLEDs 15 that are adjacent to each other and that are provided in the other slope, and as to correspond to a portion between the RLEDs 15 provided in the other slope. The slopes extend in the longitudinal direction of the GB lamp 14. As such, the wording “cross-stitch manner” refers to such a manner that: the RLEDs 15 sandwich the GB lamp 14 such that the irradiation directions of the RLEDs 15 do not directly cross with each other.

Specifically, a single RLED 15 is so provided in one slope as to correspond to a portion between two RLEDs 15 provided in the other slope, with the GB lamp 14 positioned between the single RLED 15 and the two RLEDs 15. In other words, the three RLEDs 15 are so provided as to be positioned in apexes of a triangle (see the triangle illustrated by dotted line a shown in FIG. 4), respectively. The RLEDs 15 are provided in this way in the slopes.

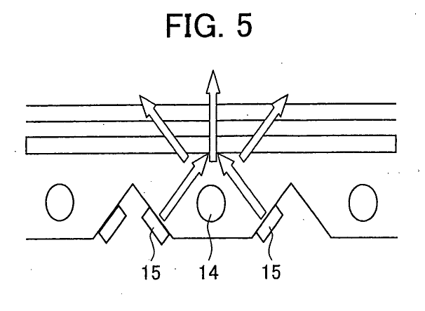

By using (i) such GB lamps 14 that are cold-cathode tubes, and (ii) such RLEDs 15 that are light emitting diodes, the color reproducibility (especially, red colors) can be improved. Here, FIG. 5 is a diagram illustrating the light emitted from each of the GB lamps 14 and each of the RLEDs 15. In cases where the GB lamps 14 and the RLEDs 15 are provided in the aforementioned manner, the light emitted from the RLED 15 can be efficiently mixed with the light emitted from the GB lamp 14.

Specifically, the light emitted from the GB lamp 14 expands concentrically with respect to the GB lamp 14. In other words, the intensity of the light emitted from the GB lamp 14 becomes weaker, as the light travels further from the GB lamp 14. On the other hand, the RLED 15 emits the light in a direction leaning at a certain angle with respect to the diffusing plate 21. Therefore, in a certain distance from the RLED 15, the intensity of the light thus emitted from the RLED 15 is the strongest in the light emitting direction, and becomes weaker as the light is deviated greater from the light emitting direction.

Therefore, in cases where the RLED 15 is so provided as to emit the light in a direction perpendicular to the diffusing plate 21, the luminance of the light to be irradiated from the backlight unit 3 is caused to be uneven due to a relation with intensity distribution of the light that is emitted from the GB lamp 14, and that is mixed with the light emitted from the RLED 15. This makes it difficult to attain uniform white light. However, in cases where the RLED 15 emits the light in the direction leaning at the certain angle with respect to the diffusing plate 21, the intensity distribution of the light emitted from the RLED 15 is adjusted such that the intensity distribution of the light emitted from the RLED 15 becomes suitable for the intensity distribution of the light emitted from the GB lamp 14.

This makes it possible to efficiently mix (i) the light emitted from the RLED 15, with (ii) the light emitted from the GB lamp 14. Note that the adjustment of the intensity distribution of the light emitted from the RLED 15 can be carried out by adjusting the angle of the slope of each of the projection portions of the base 17. With this, the light emitted from the RLED 15, and the light emitted from the GB lamp 14 are mixed so that the uniform white light is attained.

Further, the light emitted from the GB lamp 14 and the light emitted from the RLED 15 can be mixed uniformly even in the case where the light emitting direction of the RLED 15 corresponds to the direction perpendicular to the diffusing plate 21. However, for attainment of the uniform mixing in this case, distance from each of the light sources (the GB lamp 14 and the RLED 15) to the light emitting section 20 needs to be sufficiently secured. In contrast, consider the case where the RLED 15 is provided such that the light emitting direction of the RLED 15 leans at the certain angle with respect to the diffusing plate 21. In this case, the light emitted from the GB lamp 14 can be effectively mixed with the light emitted from the RLED 15 even when the distance is short from each of the GB lamp 14 and the RLED 15 to the light emitting section 20. This allows the backlight unit 3 to be thinner.

Note that the angle (light emitting angle of the RLED 15) of the slope in which the RLED 15 is provided may be arbitrarily set such that the mixing is optimally carried out. The setting of the angle may be carried out in consideration of (i) the length of the diameter of the GB lamp 14, (ii) the intensity of the light to be emitted from the GB lamp 14, (iii) the intensity of the light to be emitted from the RLED 15, and the like.

Further, the present embodiment assumes that: the RLEDs 15 are so provided as to be positioned in the apexes of the triangle respectively, thus sandwiching the GB lamp 14. However, the positions in which the RLEDs 15 are provided are not limited to this. For example, the RLEDs 15 are provided in the slopes sandwiching the GB lamp 14, in such a manner that: RLEDs 15 are so provided in one slope as to correspond to RLEDs 15 provided in the other slope, and intervals between the RLEDs 15 are the same. In other words, in this case, the RLEDs 15 are provided in the slopes sandwiching the GB lamp 14, in such a manner that two adjacent RLEDs 15 provided in one slope, and two adjacent RLEDs 15 provided in the other slope are positioned in apexes of a quadrangle (square), respectively. Namely, the RLEDs 15 are provided such that the RLEDs 15 sandwich the GB lamp 14, and such that the irradiation directions of the RLEDs 15 directly cross with each other respectively.

However, it is preferable that the RLEDs 15 be provided alternately in the slopes facing each other, i.e., the RLEDs 15 be so provided as to be positioned in the apexes of the triangle, respectively. Particularly, for example, consider a case where the intervals are long between the RLEDs 15 provided in each of the slopes facing each other. In such a case, the RLEDs 15 provided alternately in the slopes facing each other make it possible to emit surface light more uniform than surface light emitted by the RLEDs 15 which are so provided in the slopes as to correspond to each other. Especially, it is preferable that three RLEDs 15 are so provided as to be positioned in apexes of an equilateral triangle, respectively. This allows realization of more uniform surface light emitting.

Further, the longer the diameter of each of the GB lamps 14 is, the more the GB lamp 14 shields the light emitted from each of the RLEDs 15. In view of this, the RLED 15 is so provided that the light emitting direction of the RLED 15 leans at the certain angle with respect to the diffusing plate 21, rather than that light emitting direction thereof is perpendicular to the diffusing plate 21. This makes it possible to efficiently mix (i) the light emitted from the RLED 15, with (ii) the light emitted from the GB lamp 14.

Explained next is color reproducibility of the light emitted from each of (i) the backlight unit 3 having the above structure, and (ii) the liquid crystal display device 1 including the backlight unit 3.

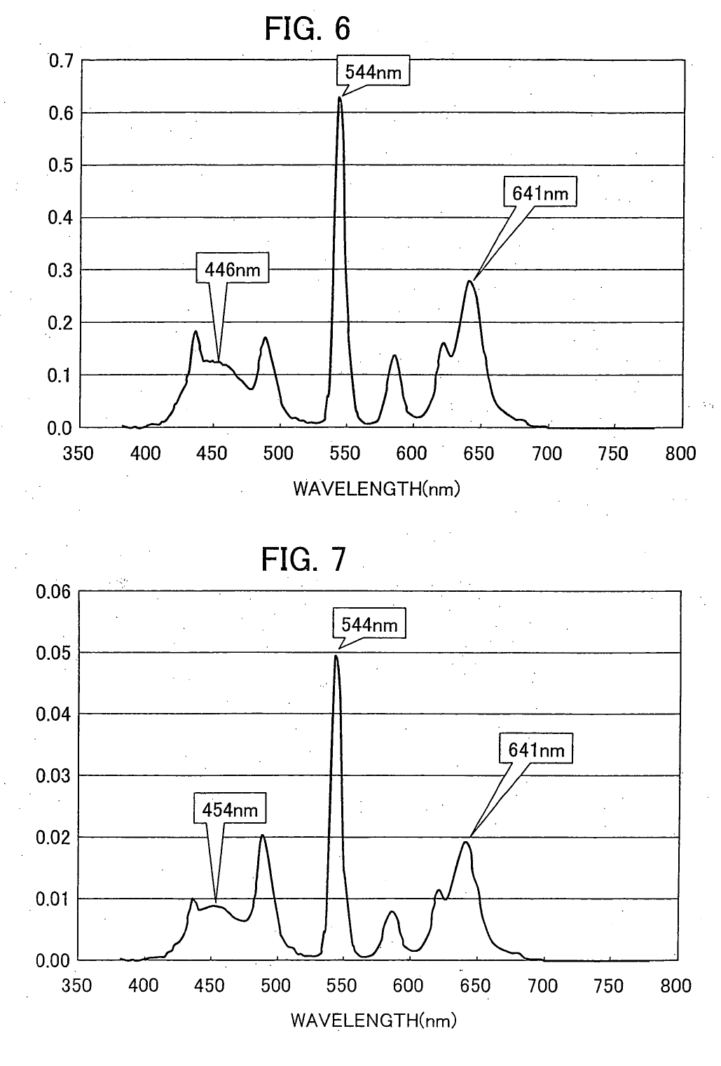

FIG. 6 is a diagram illustrating a luminescence spectrum of the light emitted from the backlight unit 3 having the above structure. Meanwhile, FIG. 7 is a diagram illustrating a luminescence spectrum of the light emitted from the liquid crystal display device 1 including the backlight unit 3.

See FIG. 6. In the luminescence spectrum of the light emitted from the backlight unit 3, peaks come in the vicinity of wavelengths of 446 nm, 544 nm, and 641 nm, respectively. The peak coming in the vicinity of the wavelength of 446 nm is a luminescence spectrum corresponding to blue. The peak coming in the vicinity of the wavelength of 544 nm is a luminescence spectrum corresponding to green. The peak coming in the vicinity of the wavelength of 641 nm is a luminescence spectrum corresponding to red.

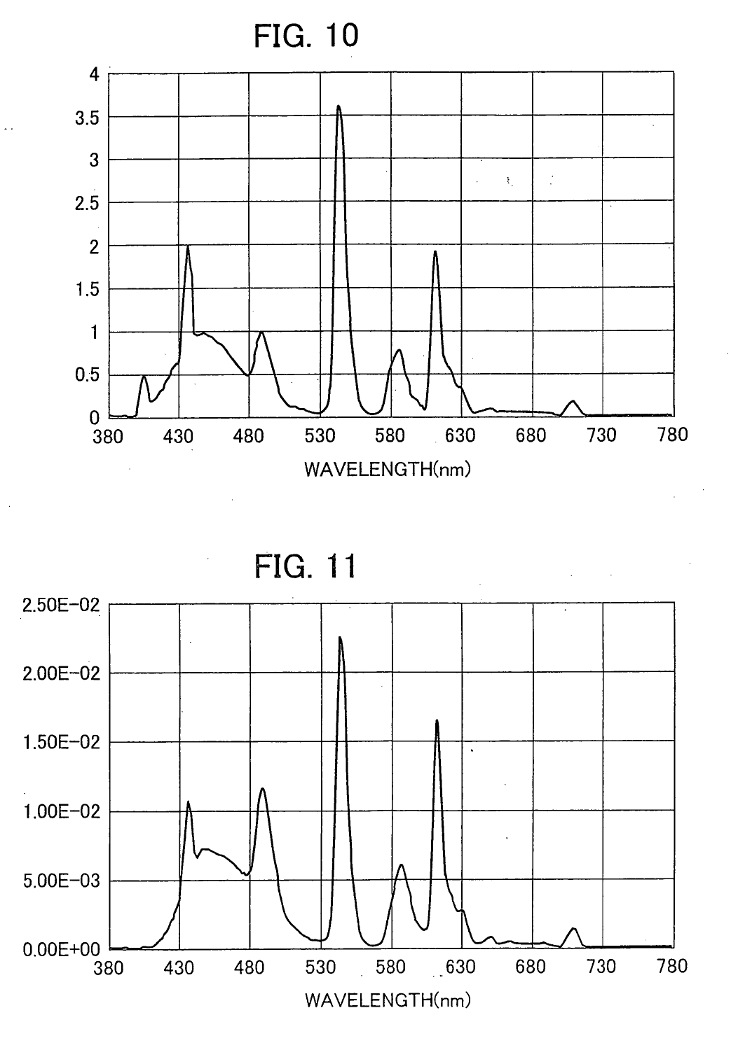

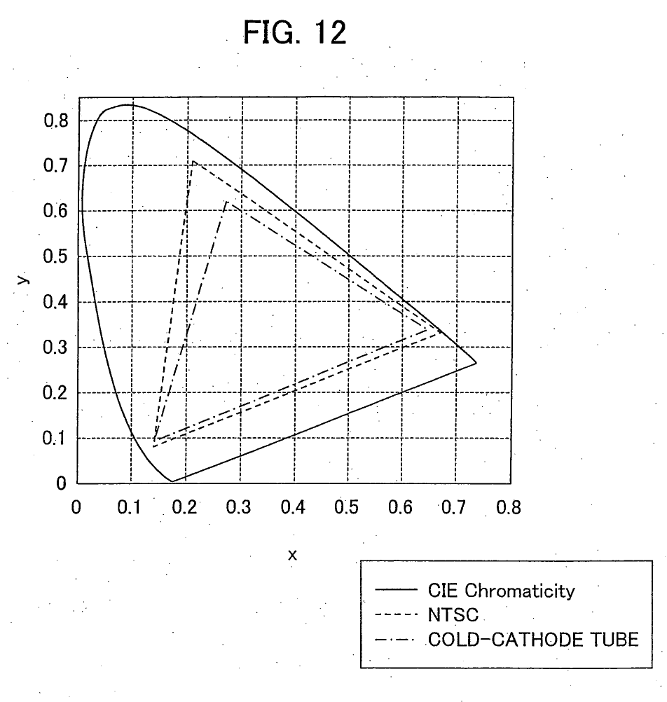

Now, compare (i) the luminescence spectrum shown in FIG. 6, with (ii) the luminescence spectrum (see FIG. 10) of light emitted from the conventional structure. The comparison clarifies that: the peak of the luminescence spectrum corresponding to blue in conventional technique, and the peak of the luminescence spectrum corresponding to blue in the present embodiment come in the vicinity of substantially the same wavelength; and the peak of the luminescence spectrum corresponding to green in the conventional technique, and the peak of the luminescence spectrum corresponding to green in the present embodiment come in the vicinity of substantially the same wavelength. In contrast, the peak of the luminescence spectrum corresponding to red in the present embodiment comes in a deeper red side as compared with the peak of the luminescence spectrum corresponding to red in the conventional technique. In other words, the peak of the luminescence spectrum corresponding to red in the present embodiment comes in a wavelength longer than that in the peak of the luminescence spectrum corresponding to red in the conventional technique.

In the meanwhile, see FIG. 7. In the luminescence spectrum of the light emitted from the liquid crystal display device 1 including the backlight unit 3, peaks come in the vicinity of wavelengths of 454 nm, 544 nm, and 641 nm, respectively. The peak coming in the vicinity of the wavelength of 454 nm is a luminescence spectrum corresponding to blue. The peak coming in the vicinity of the wavelength of 544 nm is a luminescence spectrum corresponding to green. The peak coming in the vicinity of the wavelength of 641 nm is a luminescence spectrum corresponding to red.

Now, compare (i) the luminescence spectrum shown in FIG. 7, with (ii) the luminescence spectrum (see FIG. 11) of the light emitted from the conventional structure. The comparison clarifies that: the peak of the luminescence spectrum corresponding to blue in the conventional technique, and the peak of the luminescence spectrum corresponding to blue in the present embodiment come in the vicinity of substantially the same wavelength; and the peak of the luminescence spectrum corresponding to green in the conventional technique, and the peak of the luminescence spectrum corresponding to green in the present embodiment come in the vicinity of substantially the same wavelength. In contrast, the peak of the luminescence spectrum corresponding to red in the present embodiment comes in a deeper red side as compared with the peak of the luminescence spectrum corresponding to red in the conventional technique. In other words, the peak of the luminescence spectrum corresponding to red in the present embodiment comes in a wavelength longer than that in the peak of the luminescence spectrum corresponding to red in the conventional technique.

Thus, as shown in the respective luminescence spectrums of FIG. 6 and. FIG. 7, the structure of the backlight unit 3 of the present embodiment allows a wide color reproduction range of the light emitted from the backlight unit 3.

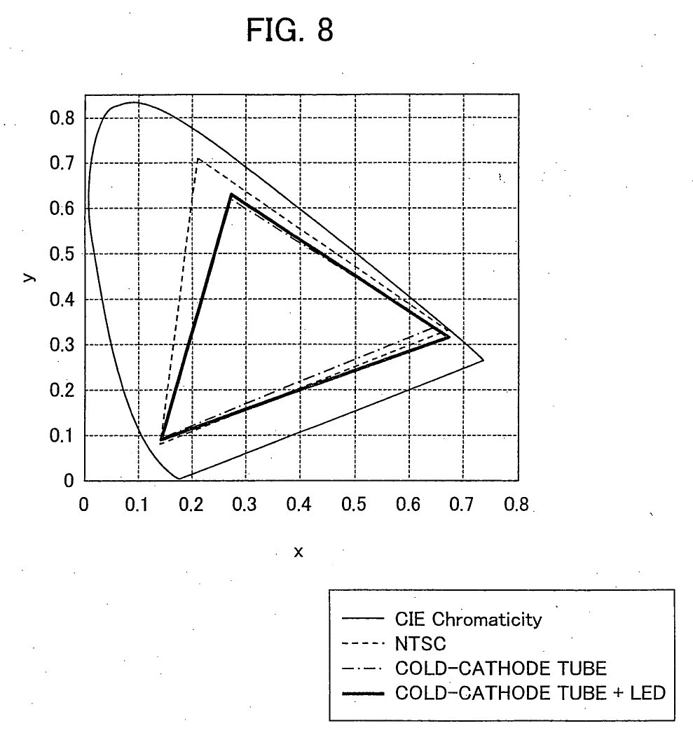

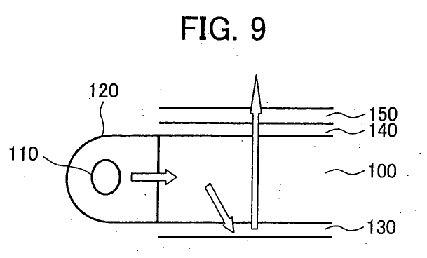

Further, FIG. 8 illustrates an NTSC ratio representing the color reproducibility in the liquid crystal display device 1 according to the present embodiment. The wording “NTSC ratio” refers to an area ratio of (i) the chromaticity region defined in accordance with a standard set by the National Television Standards Committee (NTSC), and (ii) the color reproduction range. See graphs in FIG. 8. The graph indicated by a thin solid line shows the CIE chromaticity. The wording “CIE chromaticity” refers to a color scale which was established by the International Commission on Illumination, and which uses color coordinates so as to express output energy of light beams having wavelengths falling within a range of those of visible light beams. Indicated by a dotted line is the chromaticity region (color reproduction range) which was defined in accordance with the standard set by the NTSC, and which allows for theoretically the most ideal color reproducibility (100%). Indicated by a dashed line is a color reproduction range in a backlight unit merely using a cold-cathode tube, i.e., is color reproducibility in the liquid crystal display device including the conventional backlight unit. Indicated by a thick solid line is the color reproduction range in the liquid crystal display device including the cold-cathode tube and the LED, i.e., is color reproducibility in the liquid crystal display device of the present invention.

As shown in FIG. 8, the conventional liquid crystal display device has an NTSC ratio of 74.2%. On the other hand, the liquid crystal display device 1 according to the present invention has an NTSC ratio of 81.0%. This clarifies that the color reproducibility is improved. Further, three apexes of each graph shown in FIG. 8 corresponds to R, G, and B, respectively. The apex corresponding to R has the largest value in the x-axis.

FIG. 8 clarifies that the liquid crystal display device 1 has a wider range corresponding to R, as compared with the conventional liquid crystal display device. Therefore, it is apparent that the color reproducibility for red is improved. Further, the liquid crystal display device 1 of the present invention uses the GB lamp 14 as a light source for emitting green and blue light, and uses the RLED 15 as a light source for emitting red light, with the result that the luminance in the liquid crystal display device 1 is improved as compared with that in the liquid crystal display device including the conventional backlight in which only the phosphor tube is used as a light source.

Explained next is a method for driving the backlight unit 3 of the present invention.

The cold-cathode tube such as the GB lamp 14 used in the backlight unit 3 according to the present embodiment has a temperature property different from that of the light emitting diode such as the RLED 15 used therein. In other words, the GB lamp 14 and the RLED 15 are different in terms of a rate of a light amount (light intensity) increase caused in response to voltage application (at the moment of rising).

Specifically, the GB lamp 14 starts emitting the light in response to the voltage application. As time passes, the light amount (light intensity) increases. After a certain time passes, the light amount reaches a predetermined light amount (light intensity). Meanwhile, simultaneously with the voltage application, the RLED 15 emits light having a predetermined light amount (light intensity). In other words, at the moment of the rising, the RLED 15 does not need a period for increasing the light amount (light intensity) to the predetermined light amount, but emits, simultaneously with the voltage application, the light having the predetermined light amount (light intensity).

Further, the light emission by the GB lamp 14 and the RLED 15 causes heat emission. This causes increase of ambient temperature of the GB lamp 14 and RLED 15 in the backlight unit 3, as time passes since the voltage application (since the start of the light emitting). The ambient temperature change causes a change of the light amount (light intensity) in each of the GB lamp 14 and the RLED 15; however, the light amount (light intensity) of the GB lamp 14, and that of the RLED 15 are changed differently.

Specifically, the GB lamp 14 has such a property that the light intensity is improved in response to the increase of the ambient temperature; whereas the RLED 15 has such a property that the light intensity is decreased in response to the increase of the ambient temperature. Therefore, the ambient temperature change occurring as time passes gradually changes a balance between (i) the light intensity (luminance) of the blue and green light emitted from the GB lamp 14, and (ii) the light intensity (luminance) of the red light emitted from the RLED 15.

In other words, the light intensity (luminance) of the light emitted from the GB lamp 14, and that of the light emitted from the RLED 15 become different from each other at the moment of the rising of the GB lamp 14 and the RLED 15, and the light intensities are different from each other as time passes. Therefore, in order to avoid a color tone change of the white light to be emitted from the backlight unit 3, the liquid crystal display device 1 monitors the respective light intensities of the light emitted from the GB lamp 14 and the RLED 15, and carries out control such that the balance is always invariable between the light intensities (luminances).

Specifically, the control for constantly securing the invariable light intensity (chromaticity) of the light to be emitted from the backlight unit 3 is carried out, e.g., as follows. That is, a sensor (not shown) is provided in the liquid crystal display device 1 so as to monitor the light intensities of the light beams respectively emitted from the GB lamp 14 and the RLED 15, and a control current for the GB lamp 14 and a control current for the RLED 15 are adjusted in accordance with a monitored change of each of the light intensities of the light beams.

As described above, the lighting device according to the present invention is arranged such that: the second light source is provided such that the light emitting direction of the second light source does not corresponds to the direction in which the irradiating section irradiates the light. This makes it possible to uniformly emit light via the entire irradiating section. Moreover, red colors in various wavelengths can be selected. This allows attainment of a wide color reproduction range of red.

Further, as described above, the liquid crystal display device according to the present invention includes the aforementioned lighting device. This makes it possible to carry out display with the use of the light Which has such a wide color reproduction range and which is uniformly irradiated, with the result that an image can be displayed With higher quality.

It is preferable to arrange the lighting device according to the present invention such that: the first light source is a light source having a line-like shape, and the second light source is a light source having a spot-like shape. Such a second light source is appropriately provided in the above structure in which such different types of light source, i.e., the line-like light source and the spot-like light source are used together. This makes it possible to uniformly irradiate the surface light.

It is preferable to arrange the lighting device according to the present invention such that: the second light sources are provided such that the second light sources sandwich the first light source, and such that the light emitting direction of each of the second light sources crosses with a direction in which light is perpendicularly emitted from the first light source to the irradiation surface. The above structure makes it possible to effectively mix (i) the light emitted from the first light source, with (ii) the light emitted from the second light source. Accordingly, light having higher luminance can be irradiated to outside.

It is preferable to arrange the lighting device according to the present invention such that: the second light sources are provided in parallel with longitudinal sides of the first light source so as to sandwich the first light source in a cross-stitch manner. This makes it possible to irradiate light whose luminance is even and uniform. Here, the wording “cross-stitch manner” refers to such a manner that: the second light sources sandwich the first light source such that the irradiation directions of the second light sources do not directly cross with each other.

It is preferable to arrange the lighting device according to the present invention such that: the first light source is a light source for emitting blue and green light, and the second light source is a light source for emitting red light. In the structure above, the light source for emitting the blue and green light, and the light source for emitting the red light are separately provided as such. This makes it possible to select, among red colors in various wavelengths, a red color to be rendered to the light to be emitted from the second light source. This allows attainment of a wide color reproduction range of red.

It is preferable to arrange the lighting device according to the present invention such that: the first light source is a discharge tube, and the second light source is a light emitting diode. The above structure makes it possible to arbitrarily select (i) a color of the light emitted from the discharge tube serving as the first light source, and (ii) a color of the light emitted from the light emitting diode serving as the second light source. Accordingly, a light source suitable for a color of light to be irradiated can be used. Particularly, the use of a red light emitting diode allows attainment of a wide color reproduction range of red.

A liquid crystal display device according to the present invention may include the aforementioned lighting device. The above structure, i.e., the liquid crystal display device including the lighting device makes it possible to carry out display with the use of the light which has such a wide color reproduction range and which is uniformly irradiated. Particularly, the use of the lighting device for a backlight allows the liquid crystal to display an image with higher quality.

It is preferable to arrange the backlight device according to the present embodiment such that the light source surface has a light reflecting function. The above structure allows the light source surface to reflect the light emitted from the line-like light source, so that unevenness in luminance of the light emitted from each line-like light source is improved. This allows further uniform light emitting.

It is preferable to arrange the backlight device according to the present embodiment such that: the spot-like light sources are provided along the line-like light source.

It is preferable to arrange the backlight device according to the present embodiment such that: the spot-like light sources are provided at even intervals.

It is preferable to arrange the backlight device according to the present embodiment such that: the spot-like light sources are provided in the respective light source surfaces so as to sandwich the line-like light source in a cross-stitch manner.

The backlight device according to the present embodiment may be arranged such that: the line-like light source is a light source for emitting blue and green light, and the spot-like light source is a light source for emitting red light.

The backlight device according to the present embodiment may be arranged such that the line-like light source is a discharge tube, and the spot-like light source is a light emitting diode.

A liquid crystal display device according to the present embodiment includes a backlight device, the backlight device, including: a line-like light source; and one or more light source surfaces, each of which includes a plurality of spot-like light sources, said backlight device mixing (i) light emitted from the line-like light source, with (ii) light emitted from each of the spot-like light sources, each of the light source surfaces leaning, to a flat surface including the line-like light source, in a direction of a light irradiation surface that is a surface opposite to the flat surface including the line-like light source.

The present invention is applicable to at least a lighting device which uses a discharge tube as a light source for emitting blue and green light, and which uses an LED for emitting red light. A specific example of the discharge tube is a cold-cathode tube. Further, the present invention is applicable to a liquid crystal display device using such light sources for a vertical type backlight. Therefore, the present invention is applicable to (i) a lighting device, (ii) a liquid crystal display device including the lighting device, (iii) a television using the liquid crystal display device, (iv) a monitor using the liquid crystal display device, and the like.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

What is claimed is:

1. A lighting device, comprising:
a first light source for emitting light having one or more colors;
one or more second light sources each for emitting light having a color different from the colors of the light emitted from the first light source; and
an irradiating section for irradiating, to outside, the light emitted from the first light source and each of the second light sources,
the irradiating section having an upper surface which serves as an irradiation surface,
the first light source and the second light source being provided under the irradiating section,
the second light source being provided such that a light emitting direction in which the second light source emits the light does not correspond to a direction perpendicular to the irradiation surface.

2. The lighting device as set forth in claim 1, wherein:
the first light source is a light source having a line-like shape, and the second light source is a light source having a spot-like shape.

3. The lighting device as set forth in claim 2, wherein:
the second light sources are provided such that the second light sources sandwich the first light source, and such that the light emitting direction of each of the second light sources crosses with a direction in which light is perpendicularly emitted from the first light source to the irradiation surface.

4. The lighting device as set forth in claim 2, wherein:
the second light sources are provided in parallel with longitudinal sides of the first light source so as to sandwich the first light source in a cross-stitch manner.

5. The lighting device as set forth in claim 1, wherein:
the first light source is a light source for emitting blue and green light, and the second light source is a light source for emitting red light.

6. The lighting device as set forth in claim 1, wherein:
the first light source is a discharge tube, and the second light source is a light emitting diode.

7. A backlight device, comprising:
a line-like light source; and
one or more light source surfaces, each of which includes a plurality of spot-like light sources,
said backlight device mixing (i) light emitted from the line-like light source, with (ii) light emitted from each of the spot-like light sources,
each of the light source surfaces leaning, to a flat surface including the line-like light source, in a direction of a light irradiation surface that is a surface opposite to the flat surface including the line-like light source.

8. The backlight device as set forth in claim 7, wherein:
the light source surface has a light reflecting function.

9. The backlight device as set forth in claim 7, wherein:
the spot-like light sources are provided along the line-like light source.

10. The backlight device as set forth in claim 9, wherein:
the spot-like light sources are provided at even intervals.

11. The backlight device as set forth in claim 10, wherein:
the spot-like light sources are provided in the respective light source surfaces so as to sandwich the line-like light source in a cross-stitch manner.

12. The backlight device as set forth in claim 7, wherein:
the line-like light source is a light source for emitting blue and green light, and the spot-like light source is a light source for emitting red light.

13. The backlight device as set forth in claim 7, wherein:
the-line-like light source is a discharge tube, and the spot-like light source is a light emitting diode.

14. A liquid crystal display device, comprising:
a lighting device,
said lighting device, including:
a first light source for emitting light having one or more colors;
one or more second light sources each for emitting light having a color different from the colors of the light emitted from the first light source; and
an irradiating section for irradiating, to outside, the light emitted from the first light source and each of the second light sources,
the irradiating section having an upper surface which serves as an irradiation surface,
the first light source and the second light source being provided under the irradiating section,
the second light source being provided such that a light emitting direction in which the second light source emits the light does not correspond to a direction perpendicular to the irradiation surface.

15. A liquid crystal display device, comprising:
a backlight device,
said backlight device, including:
a line-like light source; and
one or more light source surfaces, each of which includes a plurality of spot-like light sources,
said backlight device mixing (i) light emitted from the line-like light source, with (ii) light emitted from each of the spot-like light sources,
each of the light source surfaces leaning, to a flat surface including the line-like light source, in a direction of a light irradiation surface that is a surface opposite to the flat surface including the line-like light source.
